(19) United States
(12) Patent Application Publication
(10) Pub. No.: US 2025/0113008 A1
(43) Pub. Date: Apr. 3, 2025

(54) OUTPUT IMAGE ADJUSTMENT DEVICE, PROJECTION DEVICE, AND IMAGE ADJUSTMENT METHOD

(71) Applicant: LAPIS Technology Co., Ltd., Yokohama-shi (JP)

(72) Inventor: Tatsuru SHINODA, Yokohama-shi (JP)

(73) Assignee: LAPIS Technology Co., Ltd., Yokohama-shi (JP)

(21) Appl. No.: 18/897,837

(22) Filed: Sep. 26, 2024

(30) Foreign Application Priority Data
Sep. 29, 2023 (JP) 2023-170661

(51) Int. Cl. H04N 5/74; G06V 10/56; G06V 10/60

(52) U.S. Cl. CPC H04N 5/74; G06V 10/56; G06V 10/60

(57) ABSTRACT

An output image adjustment device comprises: a projection unit that projects, on a projection target, a calibration image including groups of points representing coordinates in a first direction and a second direction intersecting the first direction, each of the points having a same type of color as a point adjacent in the first direction and a different type of color from a point adjacent in the second direction; an imaging unit that captures the calibration image projected on the projection target; and an image adjustment unit that adjusts coordinates of a calibrated image to be projected by the projection unit based on captured image data captured by the imaging unit.

### CROSS-REFERENCE TO RELATED APPLICATION

This application claims priority under 35 USC 119 from Japanese Patent Application No. 2023-170661 filed Sep. 29, 2023, the disclosure of which is incorporated by reference herein in its entirety.

### BACKGROUND

### Technical Field

The present disclosure relates to an output image adjustment device, a projection device, and an image adjustment method.

### Related Art

Japanese Patent Application Laid-Open (JP-A) No. 2010-271580 discloses an illumination system including a projector 1 and a camera 2, in which an illumination control device projects and captures an image of a fringe pattern whose lightness periodically changes in a first direction orthogonal to a light projection direction of a projection device, and associates a captured image and a projected image using a phase shift method in the first direction, and projects and captures an image of a fringe pattern whose lightness periodically changes in a second direction orthogonal to the first direction and associates a captured image and a projected image using a phase shift method in the second direction, thereby acquiring conversion information defining the correspondence relationship between pixels of a captured image and a projected image.

### BRIEF DESCRIPTION OF THE DRAWINGS

Embodiments will be described in detail based on the following figures, wherein:

FIG. 1 is a view illustrating a state in which a projection device according to an embodiment of the disclosure is used;

FIG. 2 is a block diagram illustrating a configuration of the projection device according to the embodiment of the disclosure;

FIG. 3 is a view illustrating an image created by an image creation unit included in a projection device according to a first embodiment of the disclosure;

FIG. 4 is a view illustrating captured image data captured by an imaging unit included in a projection target according to the first embodiment of the disclosure;

FIG. 5 is a flowchart illustrating an operation procedure of a CPU according to the first embodiment of the disclosure;

FIG. 6 is a view illustrating an image created by an image creation unit included in a projection device according to a comparative example;

FIG. 7 is a view illustrating captured image data captured by an imaging unit included in a projection target according to the comparative example;

FIG. 8 is a view illustrating an image created by an image creation unit included in a projection device according to a second embodiment of the disclosure;

FIG. 9 is a view illustrating an image created by an image creation unit included in a projection device according to a third embodiment of the disclosure;

FIG. 10 is a view illustrating an image created by an image creation unit included in a projection device according to another embodiment of the disclosure;

FIG. 11 is a view illustrating an image created by the image creation unit included in the projection device according to another embodiment of the disclosure;

FIG. 12 is a view illustrating an image created by the image creation unit included in the projection device according to another embodiment of the disclosure; and

FIG. 13 is a view of a color wheel illustrating a hue angle.

### DETAILED DESCRIPTION

Hereinafter, an example of an embodiment of the disclosure will be described with reference to the drawings. In the drawings, the same or equivalent constituent elements and parts are denoted by the same reference numerals. In addition, dimensional ratios in the drawings are exaggerated for convenience of description, and are sometimes different from actual ratios.

In each drawing, an arrow X direction is an example of a first direction of the disclosure in image data to be described later, and an arrow Y direction is an example of a second direction of the disclosure in the image data to be described later. In each drawing, the arrow X and the arrow Y are orthogonal to each other, but the technology according to the disclosure is not limited thereto as long as the arrow X direction and the arrow Y direction intersect each other.

In each drawing, an arrow X′ direction is an example of the first direction of the disclosure in captured image data to be described later, and an arrow Y′ direction is an example of the second direction of the disclosure in the captured image data to be described later.

In the disclosure, brightness L, saturation S, and a hue angle H (hue value) in the image data indicate values represented by the following Formulas (1) to (3). Note that R, G, and B in each formula are values indicating the brightness of red, green, and blue in each pixel, respectively. In addition, in each formula, Max is a function indicating a maximum value among the values in parentheses, and Min is a function indicating a minimum value among the values in parentheses.

$$L = Max ( R , G , B ) \qquad ( 1 )$$

$$S = \{ \begin{matrix}0 & if R = G = B = 0 \\ \frac{Max ( R , G , B ) - Min ( R , G , B )}{Max ( R , G , B )} & ohterwise .\end{matrix} \qquad ( 2 )$$

$$H = \{ \begin{matrix}not defined & if R = G = B \\ arctan ( \frac{R sin 0 ° + G sin 120 ° + B sin 240 °}{R cos 0 ° + G cos 120 ° + B cos 240 °} ) & ohterwise .\end{matrix} \qquad ( 3 )$$

As shown in Formula (3), the hue angle H is not defined in a case in which the brightness of red, green, and blue is equal, in other words, in black and white including neutral colors such as gray. In the following description, it is assumed that a case in which the brightness of red, green, and blue is equal is not considered when the hue angle His referred to. However, the case in which the brightness of red, green, and blue is equal is also considered regarding the brightness L and the saturation S as shown in Formulas (1) and (2).

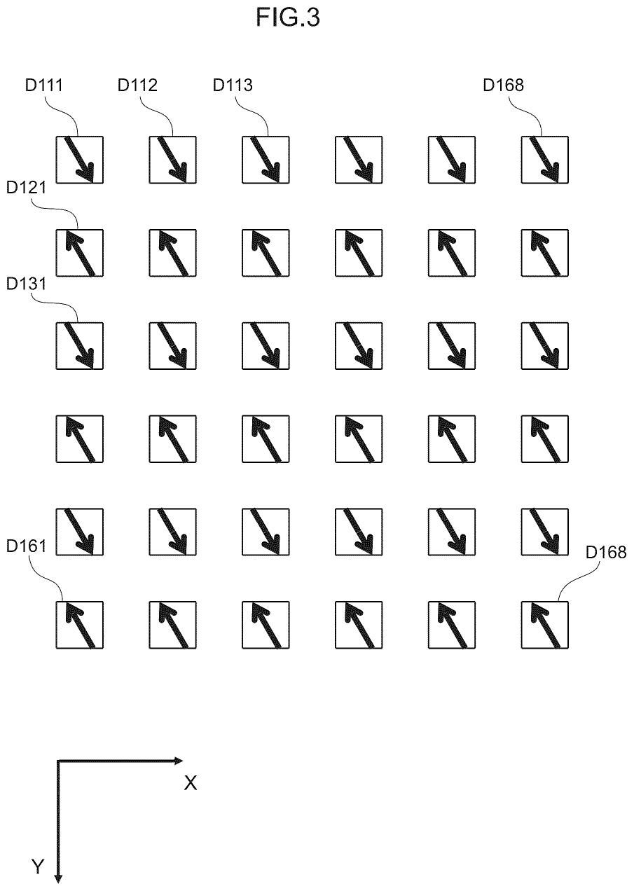

In the disclosure, the brightness L, the hue angle H, and the saturation S of a color in each drawing are represented as follows (see also FIGS. 3, 4, and 6 to 13).

The brightness L is represented by a thickness of an arrow illustrated inside an outline of an image. For example, the brightness Lis low (that is, dark) in a case in which an arrow is thin, and the brightness L is high (that is, bright) in a case in which an arrow is thick.

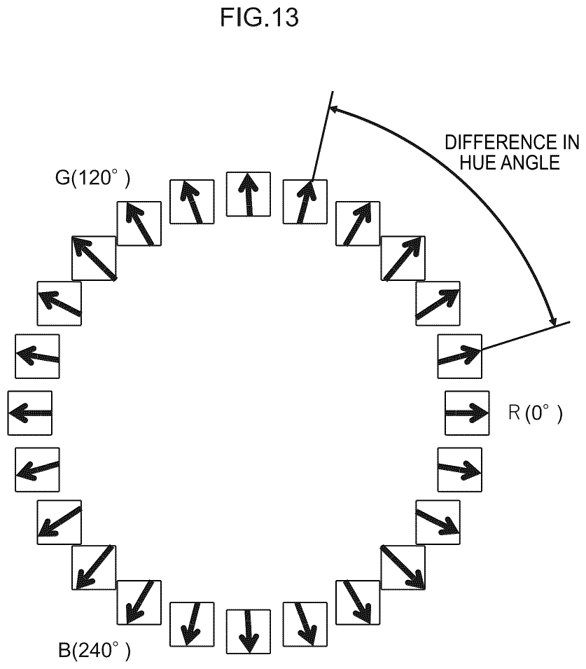

The hue angle H is represented by an angle (that is, orientation) of an arrow illustrated inside an outline of an image as illustrated in FIG. 13. For example, a case in which an arrow extends toward the right side (0°) indicates red, a case in which an arrow extends toward the upper left (120°) indicates green, and a case in which an arrow extends toward the lower left (240°) indicates blue.

The saturation S is represented by a line type of a shaft portion of an arrow illustrated inside an outline of an image. More specifically, while indicating a shaft portion by a broken line, a color with low saturation (that is, a color close to colors between white and black including gray) is indicated by a large gap (that is, a short solid line portion), and a color with high saturation (chromatic color) is indicated by a small gap (that is, a long solid line portion).

### (Configuration)

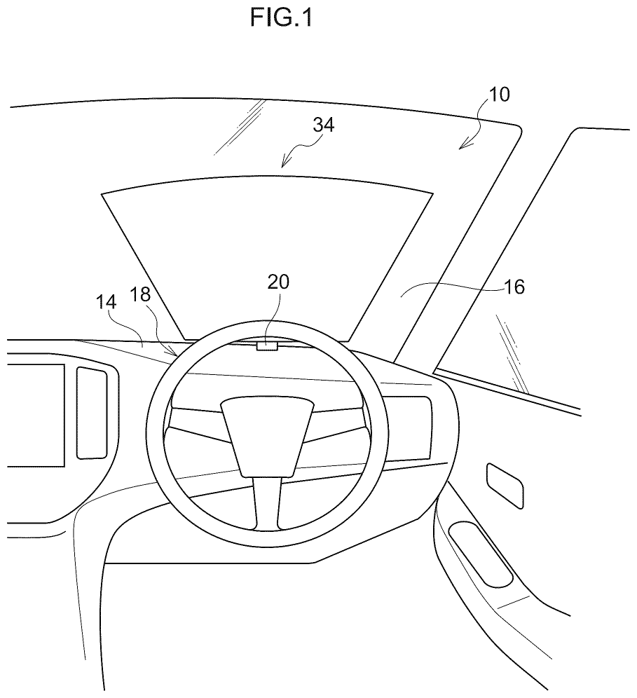

FIG. 1 is a view illustrating a state in which a projection device 20 according to the disclosure is used. As an example, the projection device 20 according to the disclosure is a so-called head-up display 10 that is arranged on a dashboard 14 of an automobile and performs projection on a front windshield 16.

As illustrated in FIG. 1, the projection device 20 is arranged in front of a steering wheel 18 as viewed from a driver of the automobile, and projects an image toward a projection area 34 of the front windshield 16. The projection area 34 is set in front of the driver as illustrated in FIG. 1, and the driver can read the image projected on the front windshield 16 and appropriately recognize necessary information.

As an example, the front windshield 16 is curved in a direction expanding forward as viewed from the driver. However, a curved shape of the front windshield 16 is not always symmetrical with respect to a longitudinal direction (that is, the vertical direction) and a lateral direction (that is, the horizontal direction and the depth direction) as viewed from the driver, and is distorted in any direction in some cases.

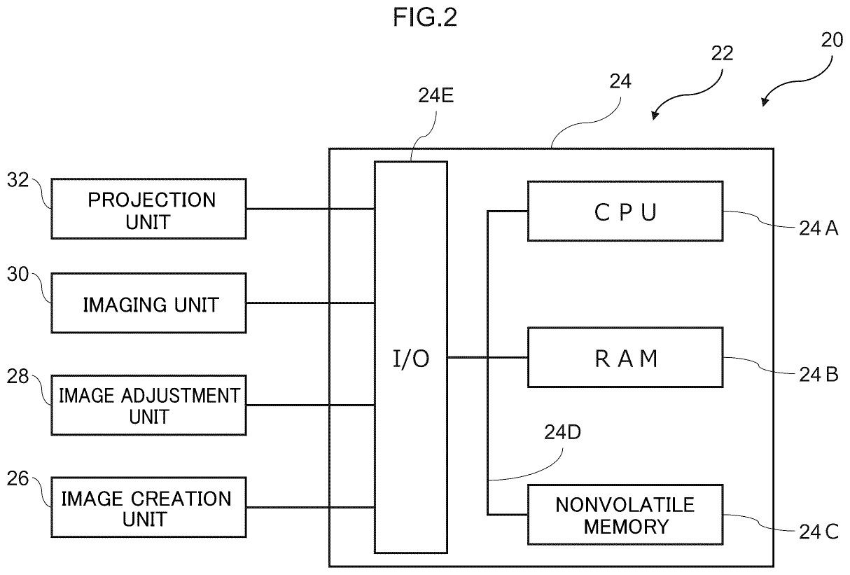

FIG. 2 is a block diagram illustrating a configuration of the projection device 20 according to the disclosure. The projection device 20 according to the disclosure includes an output image adjustment device 22 and an image creation unit 26. In addition, the output image adjustment device 22 includes a control unit 24, a projection unit 32, an imaging unit 30, and an image adjustment unit 28.

The control unit 24 includes a central processing unit (CPU) 24A, which is an example of a processor, and a random access memory (RAM) 24B which is used as a temporary work area of the CPU 24A. RAM 24B is an example of “memory”. The control unit 24 further includes a nonvolatile memory 24C, which stores a control program for causing the control unit 24 to function, and an input/output interface (I/O) 24E. The CPU 24A, the RAM 24B, the nonvolatile memory 24C, and the I/O 24E are connected via a bus 24D.

The CPU 24A of the control unit 24 reads the control program from the nonvolatile memory 24C and executes the overall control of the projection device 20 performed by the control unit 24.

The nonvolatile memory 24C is an example of a storage device in which stored information is maintained even when power supplied to each part is cut off, and is configured using, for example, a semiconductor memory but may be configured using a hard disk.

In addition, the projection unit 32, the imaging unit 30, the image adjustment unit 28, and the image creation unit 26 are connected to the I/O 24E.

The projection unit 32 is a device that projects image data created by the image creation unit 26 onto the projection area 34 of the front windshield 16 based on an operation procedure of the program executed by the CPU 24A. As an example, the projection unit 32 is a dot matrix liquid crystal projector that transmits white light emitted from a light source lamp to a liquid crystal panel, and has sub-pixels that transmit the respective colors of red, green, and blue in one pixel. In addition, the respective sub-pixels of the liquid crystal panel project a color image onto the projection area 34 by adjusting the brightness (luminance) of transmitted light. Note that the image data will be described later.

The imaging unit 30 is a device that captures the image data, projected onto the projection area 34 by the projection unit 32, based on an operation procedure of the program executed by the CPU 24A. The imaging unit 30 is so-called image sensor, for example, a CCD sensor or a CMOS sensor. In the following description, “captured image data” refers to image data created by captured by the imaging unit 30.

The image adjustment unit 28 adjusts the image data created by the image creation unit 26 based on the operation procedure of the program executed by the CPU 24A. More specifically, the image adjustment unit 28 is capable of adjusting coordinates of pixels included in the image data, and adjusts coordinate values of an image included in the image data based on the operation procedure executed by the CPU 24A, thereby adjusting the image to be projected by the projection unit 32.

The image creation unit 26 creates the image data based on the operation procedure of the program executed by the CPU 24A. The image data created by the image creation unit 26 includes a calibration image to be described later.

As illustrated in FIG. 2, the image creation unit 26 and the image adjustment unit 28 may be executed by the same device as long as the device is capable of creating image data and adjusting the image data, or may be executed by different devices. In other words, both the image creation unit 26 and the image adjustment unit 28 may be functions of the program executed by the CPU 24A. In other words, the output image adjustment device 22 may be a function of a portion of the projection device 20 other than the image adjustment unit 28.

Next, a calibration image created by the output image adjustment device 22 and the output image adjustment device 22 according to a first embodiment of the disclosure will be described with reference to FIG. 3.

### First Embodiment

The image creation unit 26 according to the present embodiment creates image data of the calibration image illustrated in FIG. 3. The calibration image includes a group of dot images, which are points representing coordinates in a lateral direction and a longitudinal direction intersecting the lateral direction, and each of the dot images has the same type of color as that of a dot image adjacent in the lateral direction and has a different type of color from that of a dot image adjacent in the longitudinal direction. In the following description, a dot image refers to an image of a point constituted by several pixels (as an example, a total of four pixels including two pixels in the longitudinal direction and two pixels in the lateral direction). As illustrated in FIG. 3, each of the dot images is arranged at a predetermined interval (as an example, twenty pixels) with an adjacent dot image in both the longitudinal direction and the lateral direction. Here, the projection area 34 of the front windshield 16 is an example of a projection target in the disclosure. In addition, the lateral direction and the longitudinal direction are examples of the first direction and the second direction according to the disclosure.

Note that the image creation unit 26 according to the present embodiment creates a color format of the image data in RGB888 format. That is, a color of each pixel in the image data is expressed by a numerical value of 256 gradations (00 to FF) for each of red, green, and blue. For example, as the color of each pixel, red is expressed by #FF0000, green is expressed by #00FF00, and blue is expressed by #0000FF.

In the present embodiment, the calibration image includes two types of colors of reddish purple (#FF00FF) and green (#00FF00) as an example. For example, in a case in which a color of any dot image is reddish purple, a color of a dot image adjacent in the lateral direction is also the same reddish purple, and a color of a dot image adjacent in the longitudinal direction is green, that is, a different color. In addition, for example, in a case in which a color of any dot image is green, a color of a dot image adjacent in the lateral direction is also the same green, and a color of a dot image adjacent in the longitudinal direction is reddish purple, that is, a different color. As described above, the same color and the different color are referred to as the “same type of color” and the “different type of color”, respectively, in the present embodiment.

In the present embodiment, as illustrated in FIG. 3, dot images in the first row (that is, dot images arranged in a horizontal row) are all reddish purple, and dot images in the second row are all green in the image data of the calibration image. In addition, reddish purple dot image and green dot image are alternately arranged similarly in the third and subsequent rows. In other words, dot images in the odd-numbered rows are all reddish purple, and dot images in the even-numbered rows are all green in the present embodiment.

In the present embodiment, both the saturation and the brightness L are set to be equal in the respective dot images. Therefore, in the calibration image in the present embodiment, the dot images in the odd-numbered rows and the dot images in the even-numbered rows are separated from each other by the hue angle H of 180° in a color wheel illustrated in FIG. 13.

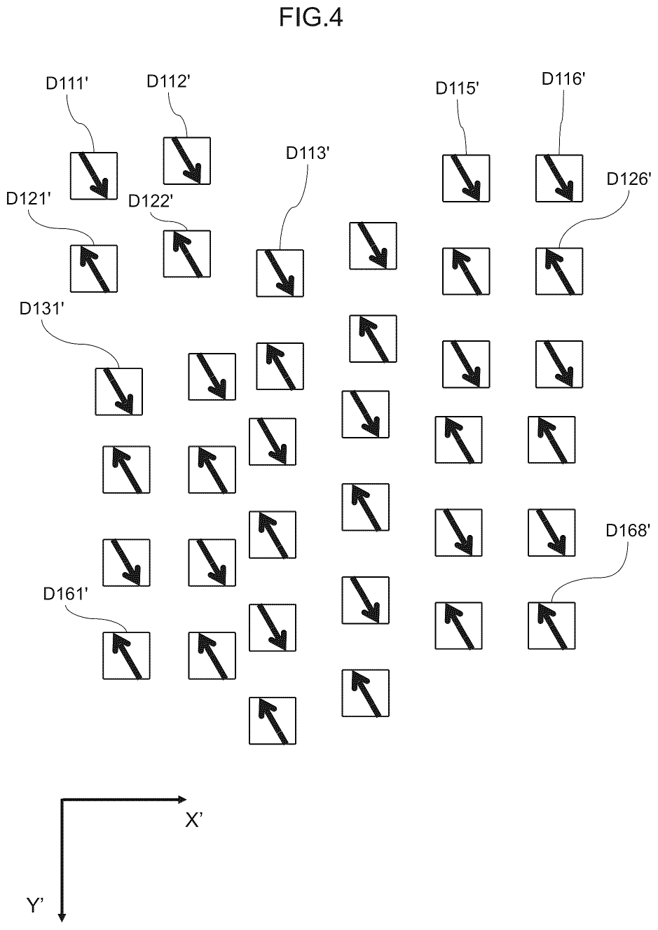

Meanwhile, there is a case in which distortion occurs in the projection area 34 of the front windshield 16, which is the projection target, and an optical system of the projection device 20 as viewed from the projection device 20. In this case, images projected from the projection device 20 may have a shape distorted as illustrated in FIG. 4 from a shape arranged in a rectangular shape as illustrated in FIG. 3. In other words, there is a case in which dot images projected from the projection device 20 are projected at positions different from assumed coordinates in projection area 34. In FIG. 3, each of the dot images is denoted by a numeral including numbers that are subsequent to D1 and indicate a row (order from the upper side in FIG. 3, for example, in the longitudinal direction) and a column (order from the left side in FIG. 3, for example, in the lateral direction). For example, D113 represents a dot image that is the first from the upper side and the third from the left side. In FIG. 3, each dot image is denoted by a numeral obtained by adding a single quotation mark “′” to the numeral corresponding to the dot image of the image data in FIG. 4. For example, D113′ indicates a dot image included in captured image data in a case in which the dot image of D113 in FIG. 4 is captured. In addition, it is assumed that dot images not denoted by numerals in FIGS. 3 and 4 are also denoted by similar numerals.

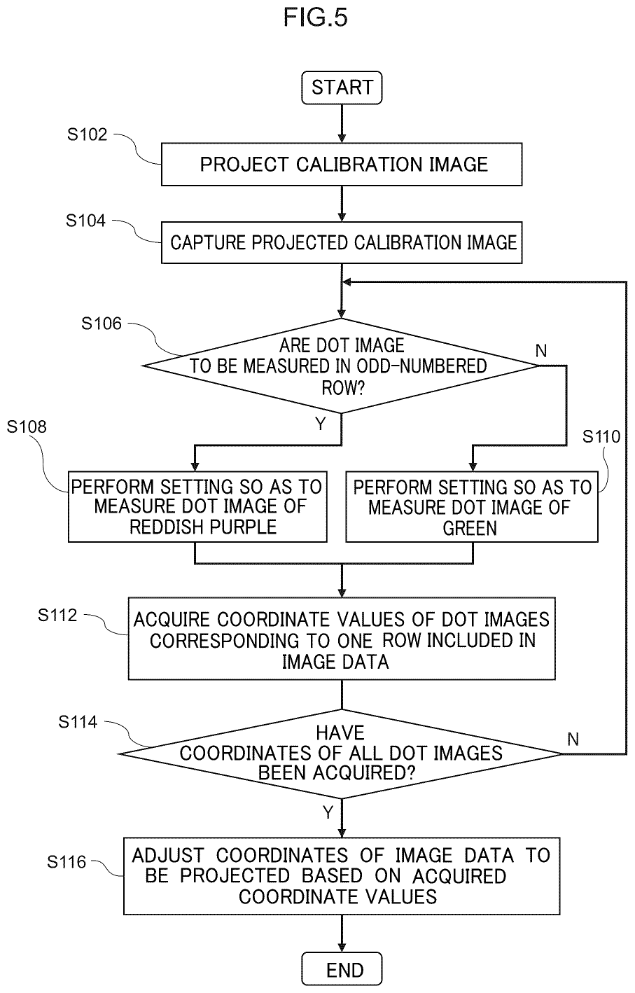

Here, the projection device 20 according to the present embodiment adjusts coordinates of the image data to be projected based on the captured image data captured by the imaging unit 30. An operation and a coordinate adjustment procedure of the output image adjustment device 22 according to the first embodiment of the disclosure will be described with specific reference to FIG. 5.

### (Coordinate Adjustment Procedure)

The CPU 24A in the present embodiment reads the program stored in the nonvolatile memory 24C and executes the procedure illustrated in FIG. 5.

First, in step S102, the CPU 24A causes the projection unit 32 to project a calibration image onto the projection area 34. Then, the CPU 24A proceeds to step S104.

Subsequently, in step S104, the CPU 24A captures the projected calibration image and stores captured image data of the captured calibration image in the RAM 24B. Then, the CPU 24A proceeds to step S106.

Subsequently, in step S106, the CPU 24A determines whether or not dot images to be measured are in the odd-numbered row. For example, in the case of proceeding to step S106 for the first time after the start of execution of the coordinate adjustment procedure, the CPU 24A makes an affirmative determination in step S106 assuming that dot images of the first row are acquired. In addition, in a case in which an affirmative determination is made in step S106, the CPU 24A proceeds to step S108. On the other hand, in a case in which a negative determination is made in step S106, the CPU 24A proceeds to step S110.

Subsequently, in step S108, the CPU 24A performs setting so as to acquire reddish purple dot images in a later step. Then, the CPU 24A proceeds to step S112.

In step S110, the CPU 24A performs setting so as to acquire green dot images in a later step. Then, the CPU 24A proceeds to step S112.

Subsequently, in step S112, the CPU 24A acquires coordinate values of dot images corresponding to one row included in the captured image data. More specifically, the CPU 24A acquires a row of dot images located at positions corresponding to the number of times of reaching S112 in the dot images included in the captured image data. For example, in the case of reaching S112 for the first time, the CPU 24A acquires coordinate values of the reddish purple dot images corresponding to the first row in the image data since step S108 has been performed. In addition, for example, in the case of reaching S112 for the second time, the CPU 24A acquires coordinate values of the green dot images corresponding to the second row in the image data since step S110 has been performed. Then, the CPU 24A proceeds to step S114.

Subsequently, in step S114, the CPU 24A determines whether coordinates of all the dot images included in the captured image data have been acquired. Then, in a case in which an affirmative determination is made in step S114, the CPU 24A proceeds to step S116. On the other hand, in a case in which a negative determination is made in step S114, the CPU 24A proceeds to step S106.

Subsequently, in step S116, the CPU 24A adjusts coordinates of the image data based on the coordinate values of the dot images acquired in step S112. More specifically, the CPU 24A calculates, for each dot image included in calibration image data and captured image data, a distance between the coordinate value of the dot image of the captured image data acquired in step S112 and the coordinate value of the dot image of the calibration image data. Then, the CPU 24A adjusts a coordinate value of each pixel included in image data formed by the image creation unit 26 according to the distance calculated in step S116. In other words, the CPU 24A adjusts coordinates of a calibrated image projected by the projection unit 32 based on the captured image data. After adjusting the coordinate value of each pixel included in the image data, the CPU 24A ends the image adjustment procedure.

In each of the steps described above, even in a case in which a color of dot images included in the captured image data captured by the imaging unit 30 is different from a color of dot images included in the calibration image, the CPU 24A determines that the colors are of the same type if such a difference is within a predetermined threshold. For example, in a case in which a color of dot images included in the calibration image is green (#00FF00) and a color of dot images in the captured image data is #00F000, the CPU 24A determines these colors as the same type of color. As an example, the predetermined threshold in the present embodiment is set to, for example, fifteen gradations in both positive and negative directions for each of red, green, and blue.

### (Projection Device 20 According to Comparative Example)

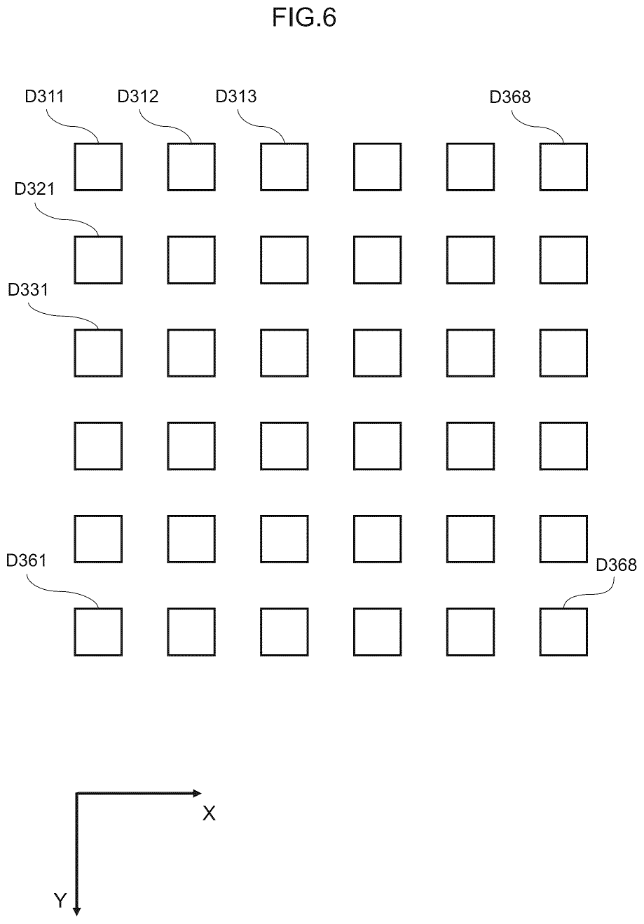

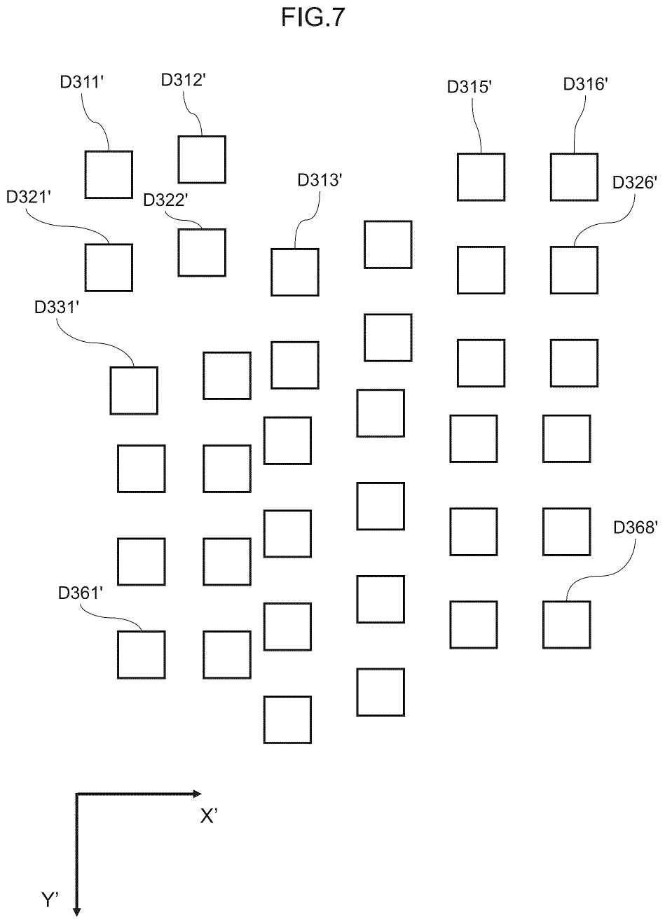

Here, FIGS. 6 and 7 illustrate calibration images output by the projection device 20 according to a comparative example of the present embodiment. As illustrated in FIGS. 6 and 7, the projection device 20 according to the comparative example projects white dot images as the calibration images, which is different from the projection device 20 according to the present embodiment. In other words, in the projection device 20 according to the comparative example, the dot images have the same color as the adjacent dot images in both the longitudinal direction and the lateral direction.

In FIG. 6, each of the dot images is denoted by a numeral including numbers that are subsequent to D3 and indicate a row (order from the upper side in FIG. 6, for example, in the longitudinal direction) and a column (order from the left side in FIG. 6, for example, in the lateral direction). For example, D313 represents a dot image that is the first from the upper side and the third from the left side. In FIG. 7, each dot image is denoted by a numeral obtained by adding a single quotation mark “′” to the numeral corresponding to the dot image of image data in FIG. 6. For example, D313′ indicates a dot image included in captured image data in a case in which the dot image of D313 in FIG. 6 is captured. In addition, it is assumed that dot images not denoted by numerals in FIGS. 6 and 7 are also denoted by similar numerals.

Here, there is a case where it is not possible to determine which row a position of any dot image belongs to in the calibration images according to the comparative example. For example, the dot image denoted by D313′ in FIG. 7 corresponds to the dot image located in the first row in FIG. 6, but is located below a dot image denoted by D322′ in FIG. 7. Therefore, in FIG. 7, in a case in which dot images in the first row are counted as “those corresponding to the first row (for example, six dot images in FIG. 7) counted from the upper side in FIG. 7”, the dot image of D313′ is recognized as the first row rather than the dot image of D322′. Similarly, in a case in which dot images in the second row are counted as “the second row (for example, six dot images from the seventh to the twelfth dot images) counted from the upper side in FIG. 7”, the dot image of D313′ is recognized as a dot image in the second row.

However, according to the projection device 20 of the present embodiment, the following action and effect can be obtained.

### Action and Effect

The output image adjustment device 22 according to the present embodiment projects a calibration image in which each group of dot images representing coordinates has the same type of color in the lateral direction and dot images adjacent in the longitudinal direction have different types of colors. Therefore, according to the output image adjustment device 22 of the present embodiment, it is difficult for the image adjustment unit 28 to misread the arrangement of the group of dot images from the captured image data in step S112. For example, the dot image indicated by D113′ in FIG. 4 is located on the lower side of the drawing in FIG. 4 than a dot image indicated by D122′. However, the dot image of D122′ that is green is not recognized as a dot image in the first row in FIG. 4 since dot images in the first row are counted as “those corresponding to the first row of reddish purple counting from the upper side in FIG. 4 (for example, six dot images in FIG. 4)”. Similarly, in a case in which dot images of the second row are counted as “those corresponding to the first row of green counting from the upper side in FIG. 4”, the dot image of D113′ that is reddish purple is not recognized as the dot image in the second row.

Therefore, according to the output image adjustment device 22, the measurement accuracy of the dot images representing the coordinates included in the calibration image is improved as compared with a case in which colors of dot images projected on a projection target are uniform.

In addition, since there is a large difference in the hue angle H between dot images adjacent in the longitudinal direction according to the output image adjustment device 22 of the present embodiment, the image adjustment unit 28 hardly misreads positions of groups of the dot images.

Therefore, according to the output image adjustment device 22, the image adjustment unit 28 can easily recognize groups of dot images of the same type based on the captured image data as compared with a case in which the hue angle H between each dot image and an adjacent dot image thereof in the longitudinal direction is small.

In addition, according to the projection device 20 of the present embodiment, the detection accuracy of the dot images representing the coordinates included in the calibration image is improved in the projection device 20 including the output image adjustment device 22 that captures the calibration image projected on the projection target and adjusts a calibrated image.

In addition, according to an image adjustment method of the embodiment, a calibration image in which each group of dot images representing coordinates has the same type of color in the lateral direction and dot images adjacent in the longitudinal direction have different types of colors. Therefore, since a calibrated image to be projected is adjusted, it is difficult to misread the arrangement of the group of dot images from captured image data of the calibration image.

Therefore, according to this image adjustment method, the measurement accuracy of the dot images representing the coordinates included in the calibration image is improved as compared with a case in which colors of dot images projected on a projection target are uniform.

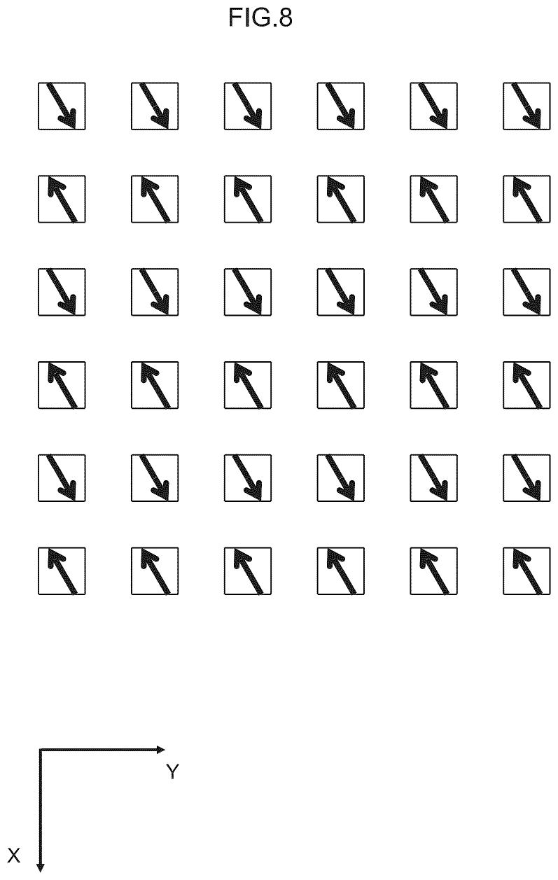

Next, a calibration image created by the output image adjustment device 22 and the output image adjustment device 22 according to a second embodiment of the disclosure will be described with reference to FIG. 8.

### Second Embodiment

FIG. 8 is a view illustrating the calibration image according to the second embodiment of the disclosure. In the present embodiment, each dot image has the same color as a dot image adjacent in the longitudinal direction, and has a different color from a dot image adjacent in the lateral direction, which is different from the first embodiment.

In the present embodiment, coordinates of captured image data obtained by capturing the calibration image projected on the projection area 34 are acquired for each column. In other words, in the present embodiment, the longitudinal and the lateral directions of image data and the captured image data are different from those of the first embodiment. Note that the other configurations and operations are similar to those of the first embodiment.

### Action and Effect

Also in the present embodiment, similar action and effect as those of the first embodiment can be obtained.

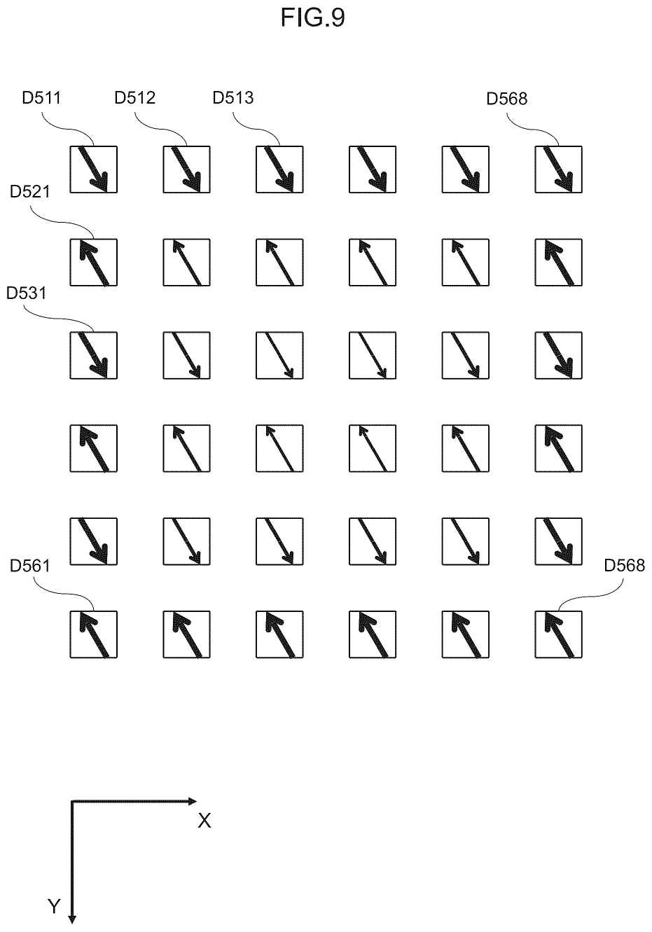

Next, a calibration image created by the output image adjustment device 22 and the output image adjustment device 22 according to a third embodiment of the disclosure will be described with reference to FIG. 9.

### Third Embodiment

FIG. 9 is a view illustrating the calibration image according to the third embodiment of the disclosure. In the present embodiment, dot images on the central side of the calibration image are lower in the brightness L than dot images on the outer side of the calibration image, which is different from the first embodiment.

In addition, the hue angle H in the present embodiment is similar to that in the first embodiment as an example. In other words, the brightness L is further made different among the dot images in the present embodiment from the dot images in the first embodiment. Note that the other configurations and operations are similar to those of the first embodiment.

In the calibration image projected on the front windshield 16, a distance from the projection unit 32 to a projection target is longer on the outer side than on the central side as illustrated in FIG. 1. In other words, the calibration image projected from the projection unit 32 onto a projection surface is darker on the outer side than on the inner side.

### Action and Effect

Here, according to the output image adjustment device 22 according to this aspect, the brightness Lis lowered on the central side of the image in a group of the dot images than on the outer side of the image. As a result, according to the output image adjustment device 22, a difference in illuminance between the dot image on the central side of the image and the dot image on the outer side of the image is reduced, and thus a range of the brightness L captured by the imaging unit 30 can be narrowed. As a result, it is easy to discriminate between the dot images of the calibration image and noise according to the output image adjustment device 22.

In the present embodiment, the illuminance of an area projected by the projection unit 32 in the projection target may be homogenized based on captured image data captured by the imaging unit 30. In addition, the CPU 24A may detect a missing dot (that is, a specific dot image whose color has not been developed) of the projection unit 32 based on the captured image data captured by the imaging unit 30.

In this case, it is easy to find the missing dot generated in the projection unit 32 that outputs the calibration image based on the captured image data in the output image adjustment device 22 that projects the calibration image onto the projection target.

In the present embodiment, the brightness L of the calibration image is adjusted to homogenize the illuminance of the area where the calibration image is projected in the projection target. Therefore, another configuration for adjusting the illuminance of the calibration image becomes unnecessary according to the output image adjustment device 22 of this aspect.

Also in the present embodiment, similar action and effect as those of the first embodiment can be obtained.

In the present embodiment, a method of homogenizing the illuminance of the area where the calibration image is projected in the projection target is not limited to the above. For example, the projection unit 32 may be provided with a filter such that the inner side of a projection area becomes dark, and the brightness L may be made equal in all dot images for a calibration image. Also in this case, it is possible to obtain an effect of easily discriminating between the dot images of the calibration image and noise.

### Another Embodiment

Note that examples in which the hue angle H or the brightness Lis different have been described in the above-described embodiments, but an embodiment according to the disclosure is not limited thereto. That is, similar action and effect as those of the above-described embodiments can be obtained as long as any one of dot images adjacent in the longitudinal direction or dot images adjacent in the lateral direction has the same type of color and the other has many types of colors in the present embodiment.

In other words, in the output image adjustment device 22 and the projection device 20 according to the disclosure, and a point having a different type of color are set as points having a difference equal to or more than a predetermined threshold in at least one of the hue angle H, the saturation S, and the brightness L. That is, the different type of color indicates that the hue angle H, the saturation S, or the brightness Lis different.

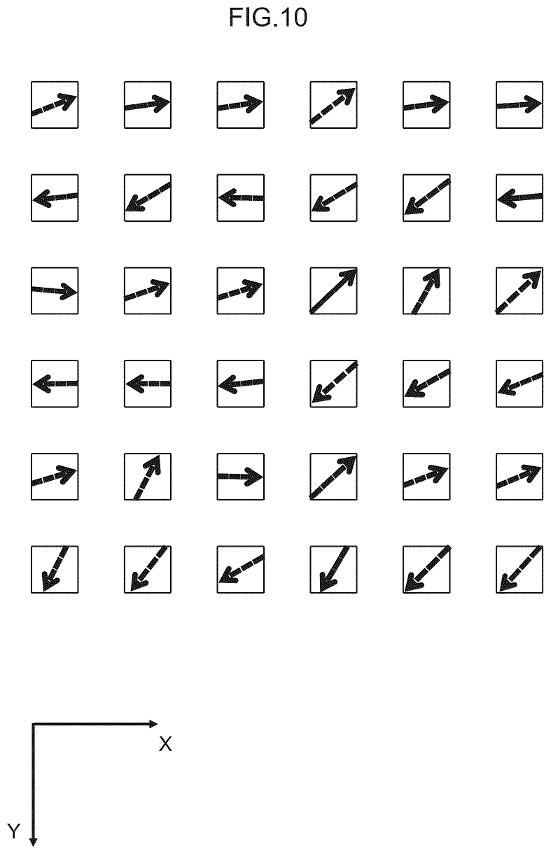

For example, FIG. 10 is a view illustrating a calibration image according to another embodiment of the disclosure. In the calibration image illustrated in FIG. 10, colors of dot images in the odd-numbered row are warm colors, and colors of dot images in the even-numbered row are cool colors, which is different from the first embodiment. In other words, the warm colors and the cool colors are used to determine the same type of color and the different type of color in the present embodiment.

In the present embodiment, the colors of the dot images in the odd-numbered row and the colors of the dot images in the even-numbered row are separated by a prescribed value or more at least in the hue angle H. That is, in an example of FIG. 10, the predetermined threshold corresponds to that a difference in the hue angle H is the prescribed value.

In the example of FIG. 10, the brightness L and the saturation S of each of the dot images are not limited. In other words, in the example of FIG. 10, the dot images in the odd-numbered row and the dot images in the even-numbered row may have the same brightness L or saturation S. Note that the other configurations and operations are similar to those of the first embodiment.

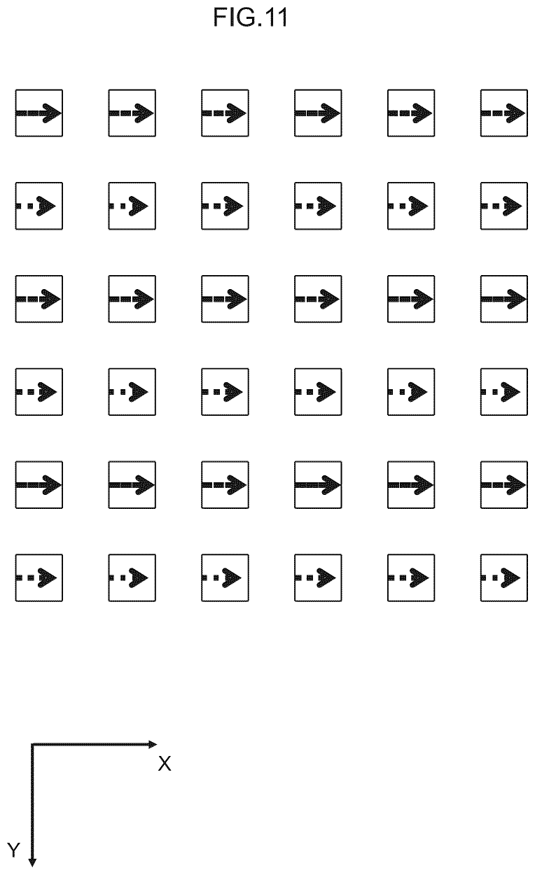

In addition, FIG. 11 is a view illustrating another calibration image according to another embodiment of the disclosure. In the calibration image illustrated in FIG. 11, colors of dot images in the odd-numbered row are chromatic colors, and colors of dot images in the even-numbered row are achromatic colors, which is different from the first embodiment. In other words, in the present embodiment, a difference in the saturation S is used to determine the same type of color and a different type of color.

In an example of FIG. 11, the brightness L and the hue angle H of each of the dot images are not limited. In other words, the dot images in the odd-numbered row and the dot images in the even-numbered row may have the same brightness L or hue angle H.

In the present embodiment, the colors of the dot images in the odd-numbered row and the colors of the dot images in the even-numbered row are different in the saturation S by at least a prescribed value or more. That is, in the example of FIG. 11, the predetermined threshold corresponds to that the difference in the saturation S is the prescribed value.

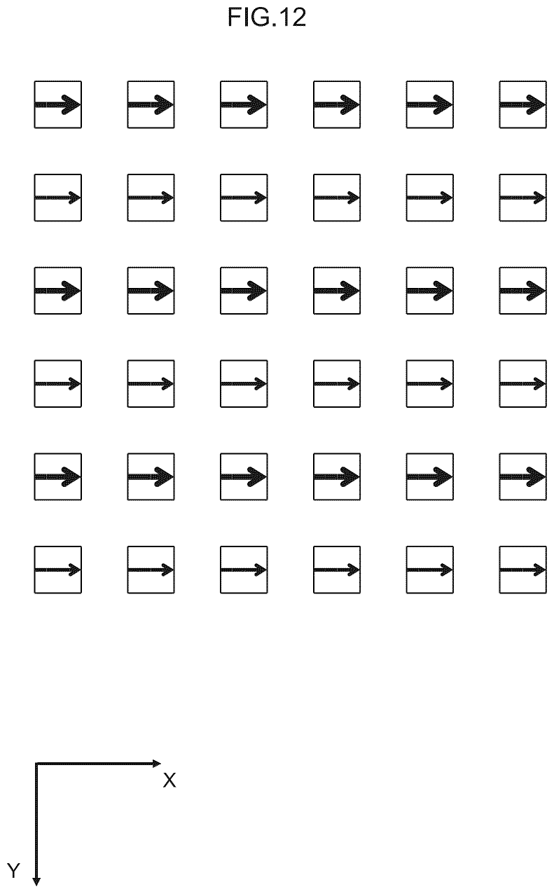

In addition, FIG. 12 is a view illustrating still another calibration image according to another embodiment of the disclosure. In the calibration image illustrated in FIG. 12, a color of dot images in the odd-numbered row is bright, and a color of dot images in the even-numbered row is dark, which is different from the first embodiment. In other words, in the present embodiment, a difference in the brightness L is used to determine the same type of color and a different type of color.

In an example of FIG. 12, the saturation S and the hue angle H of each of the dot images are not limited. In other words, the dot images in the odd-numbered row and the dot images in the even-numbered row may have the same saturation S or hue angle H.

In the present embodiment, the color of the dot images in the odd-numbered row and the color of the dot images in the even-numbered row are different in the brightness L by a prescribed value (%) or more with respect to at least a maximum value (for example, 255 in the embodiment). That is, in the example of FIG. 12, the predetermined threshold corresponds to that the difference in the brightness L is the prescribed value (%) with respect to the maximum value.

### Action and Effect

Also in the present embodiment, at least one of the hue angle H, the saturation S, and the brightness L of a point having the different type of color is different from a point adjacent in the longitudinal direction by the predetermined threshold or more. As a result, the image adjustment unit 28 can determine a point of the same type and a point of a different type by detecting a difference in at least one of the hue angle H, the saturation S, and the brightness L between points from captured image data, and thus it is difficult to misread the arrangement of groups of points from the captured image data.

Therefore, according to the output image adjustment device 22, the measurement accuracy of points representing coordinates included in the calibration image is improved as compared with a case in which each of the hue angle H, the saturation S, and the brightness L is less than a predetermined threshold with respect to a color difference between a color of the point of the same type and a color of the point of the different type.

### Other Modifications

As in the above-described embodiments, projection of a calibration image and adjustment of coordinates of a calibrated image may be performed at any time. For example, such processing may be executed at the time of shipment of the projection device 20 or at the time of shipment of an automobile equipped with the projection device 20, or may be executed by an operator or a user at any time to adjust an image projected on the front windshield 16.

Although the calibration image is directly projected on the front windshield 16 in the above description, the technology according to the disclosure is not limited thereto, and adjustment of an image may be executed by preparing another projection target for calibration and performing projection on the projection target. For example, a calibration image may be output in a state of being covered with a blackout curtain from the outside of the front windshield 16 such that the imaging unit 30 can easily read dot images.

In the above description, dot images each of which is arranged at a predetermined interval with an adjacent dot image have been described as the points representing the coordinates, but the technology according to the disclosure is not limited thereto. For example, a dot image may be arranged continuously with an adjacent dot image to form a line shape in a macroscopic view. More specifically, an image may have a grid shape including a group of lines extending in the first direction and arranged at an interval in the second direction and a group of lines extending in the second direction and arranged at an interval in the first direction. In this case, it is possible to obtain similar action and effect similar to those described above by using intersections of the lines as points representing coordinates. In addition, distortion of the projection area 34 on the projection target and the optical system of the projection device 20 can be more easily found since the line shape is formed in the macroscopic view.

In the above description, the colors of the dot images are made different between the odd-numbered row and the even-numbered row, but the technology according to the disclosure is not limited thereto. In addition, for example, three or more types of colors may be used as color types such that a color of dot images in the first row, the fourth row, the seventh row, and so on is red, dot images in the second row, the fifth row, the eighth row, and so on are green, and dot images in the third row, the sixth row, the ninth row, and so on are blue. In addition, in this case, each type of color may be periodically repeated or randomly selected as long as points adjacent in the second direction are different in types.

Note that the processing executed by the CPU 24A reading software (in other words, the program) in each of the above embodiments may be executed by various processors other than the CPU 24A. Examples of the processors in this case include a programmable logic device (PLD) whose circuit configuration can be changed after manufacturing, such as a field-programmable gate array (FPGA), a dedicated electric circuit that is a processor having a circuit configuration exclusively designed for executing specific processing, such as an application specific integrated circuit (ASIC), and the like. In addition, the processing may be executed by one of the various processors, or may be executed by any combination of two or more processors of the same type or different types (for example, a plurality of FPGAs, a combination of a CPU and an FPGA, and the like). In addition, more specifically, a hardware structure of the various processors is an electric circuit in which circuit elements such as semiconductor elements are combined.

Although an aspect in which the control program is stored (installed) in advance in the nonvolatile memory 24C has been described in each of the above embodiments, but the technology according to the disclosure is not limited thereto. The program may be provided in a form of being stored in a non-transitory storage medium such as a compact disk read only memory (CD-ROM), a digital versatile disk read only memory (DVD-ROM), or a universal serial bus (USB) memory. In addition, the program may be downloaded from an external device via a network.

Although the embodiments of the disclosure have been described above with reference to the accompanying drawings, it is obvious that a person with ordinary knowledge in the technical field to which the disclosure belongs can conceive various modifications or applications within a scope of the technical idea described in the claims, and it is understood that these naturally belong to the technical scope of the disclosure.

Note that preferred aspects of the disclosure will be further described hereinafter.

### (Supplementary Note 1)

An output image adjustment device including, comprising:

a projection unit that projects, onto a projection target, a calibration image including groups of points representing coordinates in a first direction and a second direction intersecting the first direction, each of the points having a same type of color as a point adjacent in the first direction and a different type of color from a point adjacent in the second direction;

an imaging unit that captures the calibration image projected onto the projection target; and

an image adjustment unit that adjusts coordinates of a calibrated image to be projected by the projection unit based on captured image data captured by the imaging unit.

### (Supplementary Note 2)

The output image adjustment device according to Supplementary Note 1, wherein a point having the different type of color is a point that is different, by a predetermined threshold or more, in at least one of hue, saturation, or brightness from a point adjacent in the second direction.

### (Supplementary Note 3)

The output image adjustment device according to Supplementary Note 1 or 2, wherein a central side of the calibration image has lower brightness than an outer side of the calibration image.

### (Supplementary Note 4)

A projection device, comprising:

the output image adjustment device according to any one of Supplementary Notes 1 to 3; and

an image creation unit that creates the calibrated image.

### (Supplementary Note 5)

An image adjustment method, comprising, by at least one processor:

projecting, onto a projection target, a calibration image including groups of points representing coordinates in a first direction and a second direction intersecting the first direction, each of the points having a same type of color as a point adjacent in the first direction and a different type of color from a point adjacent in the second direction;

capturing the calibration image projected onto the projection target; and

adjusting coordinates of a calibrated image to be projected based on captured image data of the captured calibration image.

### (Supplementary Note 6)

An output image adjustment device, comprising:

a projection unit that projects, onto a projection target, a calibration image expanding in a first direction and a second direction intersecting the first direction;

an imaging unit that captures the calibration image projected onto the projection target; and

an image adjustment unit that homogenizes illuminance of an area projected by the projection unit in the projection target based on captured image data captured by the imaging unit and detects coordinates of a pixel in which a dot is missing in the projection unit based on the captured image data captured by the imaging unit.

### (Supplementary Note 7)

The output image adjustment device according to Supplementary Note 6, wherein the image adjustment unit adjusts lightness of the calibration image to homogenize illuminance of an area in which the calibration image is projected in the projection target.

### (Supplementary Note 8)

A projection device, comprising:

the output image adjustment device according to Supplementary Note 6 or 7; and

an image creation unit that creates the calibration image.

### (Supplementary Note 9)

An image adjustment method, comprising, by at least one processor:

projecting, onto a projection target, a calibration image expanding in a first direction and a second direction intersecting the first direction;

capturing the calibration image projected onto the projection target;

homogenizing illuminance of an area projected in which the calibration image is projected in the projection target based on captured captured image data; and

detecting coordinates of a pixel in which a dot included in the calibration image is missing based on the captured image data.

What is claimed is:

1. An output image adjustment device, comprising:
a projection unit that projects, onto a projection target, a calibration image including groups of points representing coordinates in a first direction and a second direction intersecting the first direction, each of the points having a same type of color as a point adjacent in the first direction and a different type of color from a point adjacent in the second direction;
an imaging unit that captures the calibration image projected onto the projection target; and
an image adjustment unit that adjusts coordinates of a calibrated image to be projected by the projection unit based on captured image data captured by the imaging unit.

2. The output image adjustment device according to claim 1, wherein a point having the different type of color is a point that is different, by a predetermined threshold or more, in at least one of hue, saturation, or brightness from a point adjacent in the second direction.

3. The output image adjustment device according to claim 1, wherein a central side of the calibration image has lower brightness than an outer side of the calibration image.

4. A projection device, comprising:
the output image adjustment device according to claim 1; and
an image creation unit that creates the calibrated image.

5. An image adjustment method, comprising, by at least one processor:
projecting, onto a projection target, a calibration image including groups of points representing coordinates in a first direction and a second direction intersecting the first direction, each of the points having a same type of color as a point adjacent in the first direction and a different type of color from a point adjacent in the second direction;
capturing the calibration image projected onto the projection target; and
adjusting coordinates of a calibrated image to be projected based on captured image data of the captured calibration image.

6. An output image adjustment device, comprising:
a projection unit;
an imaging unit that captures the calibration image projected onto the projection target;
a memory; and
at least one processor coupled to the memory, wherein the at least one processor is configured to:
project, onto a projection target by the projection unit, a calibration image including groups of points representing coordinates in a first direction and a second direction intersecting the first direction, each of the points having a same type of color as a point adjacent in the first direction and a different type of color from a point adjacent in the second direction,
capture, by the imaging unit, the calibration image projected onto the projection target; and
adjust coordinates of a calibrated image, which is projected by the projection unit, based on captured image data captured by the imaging unit.

7. The output image adjustment device according to claim 6, wherein a point having the different type of color is a point that is different, by a predetermined threshold or more, in at least one of hue, saturation, or brightness from a point adjacent in the second direction.

8. The output image adjustment device according to claim 6, wherein a central side of the calibration image has lower brightness than an outer side of the calibration image.

9. A projection device, comprising:
the output image adjustment device according to claim 6,
wherein the at least one processor is configured to create the calibrated image.
